(19) United States
(12) Patent Application Publication
(10) Pub. No.: US 2025/0285458 A1
(43) Pub. Date: Sep. 11, 2025

(54) AUTOMATED OBJECTS LABELING IN VIDEO DATA FOR MACHINE LEARNING AND OTHER CLASSIFIERS

(71) Applicant: VIRGINIA TECH INTELLECTUAL PROPERTIES, INC., Blacksburg, VA (US)

(72) Inventors: Emerson Dove, Blacksburg, VA (US); Jonathan T. Black, Blacksburg, VA (US); Daniel D. Doyle, Christiansburg, VA (US)

(21) Appl. No.: 18/860,072

(22) PCT Filed: Apr. 25, 2023
(86) PCT No.: PCT/US23/66205

§ 371 Date: Oct. 25, 2024

Related U.S. Application Data
(60) Provisional application No. 63/363,526, filed on Apr. 25, 2022.

(51) Int. Cl. G06V 20/70; G01S 17/89; G06T 7/20; G06T 17/00; G06V 10/25

(52) U.S. Cl. CPC G06V 20/70; G01S 17/89; G06T 7/20; G06T 17/00; G06V 10/25; G06V 2201/07

(57) ABSTRACT

An automatic visual data labeling framework for heterogeneous data types is described. An example method can include obtaining scan data and video data that each depict a scene including an object. The scan data can be generated by a scanner. The video data can be generated by a camera. The method can also include generating a virtual representation of the scene in a virtual environment based on the scan data. The virtual representation can include a virtual representation subset corresponding to the object. The virtual environment can be associated with a virtual camera. The method can also include applying label data to the virtual representation subset to create a labeled virtual representation subset corresponding to the object. The method can also include applying the labeled virtual representation subset to the object depicted in the video data based on a correlation of the scanner, the camera, and the virtual camera.

### CROSS-REFERENCE TO RELATED APPLICATION

This application claims the benefit of and priority to U.S. Provisional Patent Application No. 63/363,526, titled “Automated Labeling of Objects in Video Data,” filed Apr. 25, 2022, the entire contents of which is hereby incorporated by reference herein.

### BACKGROUND

Machine learning models, such as object detection and image recognition models, require volumes of training data that have correctly labeled objects in a variety of backgrounds. To obtain truth data (also referred to as “ground truth data”) for making comparisons of different machine learning models or algorithms in development, someone or something, such as a computer process, must establish guidelines, constraints, and requirements for establishing baseline truth data.

Many researchers have developed unique approaches to labeling their test sets of data appropriately to ensure a high level of accuracy when reporting their results in connection with training machine learning models. One approach for labeling truth data involves using humans to select and label objects of interest in various images and/or video frames using any number of commercially available applications that facilitate such a process. Another approach for labeling truth data involves using classifiers or a set of algorithms to pre-populate truth data that is subsequently reviewed by a human for accuracy.

### SUMMARY

The present disclosure relates to the automated labeling of one or more objects depicted in visual data. More specifically, described herein is a labeling framework that can be embodied or implemented as a software architecture to label an object an initial time and then automatically (without human intervention) label the same object once or multiple times in at least one of real-world visual data or synthetic visual data based on the initial labeling of the object. For example, the labeling framework can be implemented to label an object an initial time and then automatically label the same object in all subsequent images of a dataset. In this way, the labeling framework can be implemented to automatically generate a training dataset of labeled visual data based on a single application of a label to an object depicted in, for example, an image, a video frame, a scan, or other visual data. The training dataset of labeled visual data can then be used to train a model to detect the object in various visual data. The model may include a machine learning object classifier, for example.

According to an example of the labeling framework described herein, a computing device can obtain scan data and video data that each depict a scene having an object. The scan data can be captured by a scanner and the video data can be captured by a camera, for example. The computing device can generate a virtual representation of the scene in a virtual environment based on the scan data. The virtual representation can include a virtual representation subset corresponding to the object and the virtual environment can be associated with a virtual camera. The computing device can apply label data to the virtual representation subset to create a labeled virtual representation subset corresponding to the object. The computing device can then apply the labeled virtual representation subset to the object depicted in the video data based on a correlation of the scanner, the camera, and the virtual camera.

In addition, the computing device can generate a labeled visual dataset based on the video data and the labeled virtual representation subset corresponding to the object. The labeled visual dataset can include annotations of the labeled virtual representation subset applied to the object depicted in one or more video frames of the video data. The labeled visual dataset can be indicative of a labeled training dataset that can be used to train a model to detect the object in various other visual data. In this way, the labeling framework of the present disclosure can reduce at least one of the time, computational costs, or manual labor involved with generating a labeled training dataset that can be used to train an ML model to detect an object in various visual data.

### BRIEF DESCRIPTION OF THE DRAWINGS

Many aspects of the present disclosure can be better understood with reference to the following figures. The components in the figures are not necessarily to scale, with emphasis instead being placed upon clearly illustrating the principles of the disclosure. Moreover, repeated use of reference characters or numerals in the figures is intended to represent the same or analogous features, elements, or operations across different figures. Repeated description of such repeated reference characters or numerals is omitted for brevity.

FIG. 1 illustrates a diagram of an example environment that can facilitate automated labeling of objects in visual data according to at least one embodiment of the present disclosure.

FIG. 2 illustrates a block diagram of an example computing environment that can facilitate automated labeling of objects in visual data according to at least one embodiment of the present disclosure.

FIG. 3 illustrates an example data flow that can facilitate automated labeling of objects in visual data according to at least one embodiment of the present disclosure.

FIG. 4A illustrates an example of visual data depicting objects that can be automatically labeled according to at least one embodiment of the present disclosure.

FIG. 4B illustrates an example of a mask that can facilitate automated labeling of objects in visual data according to at least one embodiment of the present disclosure.

FIG. 5A illustrates an example of visual data depicting objects that can be automatically labeled according to at least one embodiment of the present disclosure.

FIG. 5B illustrates an example of visual data depicting virtual representation subsets corresponding to objects that can be automatically labeled according to at least one embodiment of the present disclosure.

FIG. 5C illustrates an example of a mask that can facilitate automated labeling of objects in visual data according to at least one embodiment of the present disclosure.

FIG. 5D illustrates an example of labeled visual data depicting objects that have been automatically labeled according to at least one embodiment of the present disclosure.

FIG. 6 illustrates a flow diagram of an example computer-implemented method that can be implemented to facilitate automated labeling of objects in visual data according to at least one embodiment of the present disclosure.

### DETAILED DESCRIPTION

Vision-based machine learning classifiers require properly labeled images to train and improve model performance. One existing approach for labeling truth data in visual data involves using humans to select and label objects of interest in various images, video frames, or both, using any number of commercially available applications that facilitate such a process. Another approach for labeling truth data involves using classifiers or a set of algorithms to pre-populate truth data that is subsequently reviewed for accuracy by a human.

However, a problem with each of the approaches described above is that the development of a large, well-labeled dataset is expensive to produce due to the large quantity of human hours involved with labeling or segmenting the dataset or reviewing pre-populated truth data for accuracy. The human and computational capital creates significant barriers of entry for smaller companies and research teams interested in generating quality custom datasets. Moreover, the manual verification of classified data by a human utilizes more computing resources, such as more usage of network bandwidth, more central processing unit (CPU) and/or graphics processing unit (GPU) resources, and so forth.

The present disclosure provides solutions to address the above-described problems associated with labeling visual data in general and with respect to the existing approaches. The labeling framework described herein can be implemented to label an object of interest one time and then automatically (without human intervention) label the same object once or multiple times in at least one of real-world visual data or synthetic visual data based on the initial labeling of the object. For instance, the labeling framework can be implemented to apply a ground truth label to an object of interest one time and then automatically apply the ground truth label to the same object once or multiple times in one or more images, video frames of a video or a video stream, scans, or other visual data. In this way, the labeling framework can be implemented to automatically generate a training dataset of labeled visual data based on a single application of a ground truth label to an object depicted in, for example, an image, a video frame, a scan, or other visual data. The training dataset of labeled visual data can then be used to train a model to detect the object in various visual data.

The labeling framework of the present disclosure can be implemented to automatically (without human intervention) label one or more objects in visual data by performing one or more labeling methods described herein. In one labeling method, the labeling framework can project synthetic data onto one or more real-world images or video frames of a video or a video stream. In another labeling method, the labeling framework can use a textured light detection and ranging (LiDAR) scan to generate a three-dimensional (3D) point cloud of a desired area and apply label data to a portion of the 3D point cloud that corresponds to an object in the desired area. In yet another labeling method, the labeling framework can use a LiDAR scan in conjunction with a simultaneous localization and mapping (SLAM) algorithm to correlate one or more real-world images or video frames with a 3D point cloud corresponding to a desired area having an object that is depicted in the LiDAR scan. For example, the labeling framework can use a LiDAR scan in conjunction with a smoothing and mapping (SAM) algorithm to correlate one or more real-world images or video frames with a 3D point cloud corresponding to a desired area having an object that is depicted in the LiDAR scan.

The labeling methods described herein can involve a combination of identifying and segmenting desired 3D objects in, for example, a 3D point cloud or another 3D virtual representation of an area or scene having an object. The labeling methods can involve creating masks (also referred to as “mask layers”) for any combination of object pose and occlusion. Additionally, the labeling methods can involve generating two-dimensional (2D) training images having annotations of label data corresponding to objects depicted in the images. The label data can be indicative of ground truth data corresponding to the objects.

The labeling framework of the present disclosure provides several technical benefits and advantages. For example, the labeling framework described herein can allow for the offline or online automated labeling of synthetically generated visual data, real-world visual data, or both. In addition, the labeling framework can reduce the time and costs (e.g., computational costs, manual labor costs) associated with generating a labeled visual dataset that can be used to train a machine learning or artificial intelligence model that, once trained, can be used in an online environment to detect and classify, in real-time or near real-time, an object depicted in various visual data. To this end, the present disclosure describes various solutions that reduce usage of network bandwidth, CPU and GPU resources, among other computational benefits.

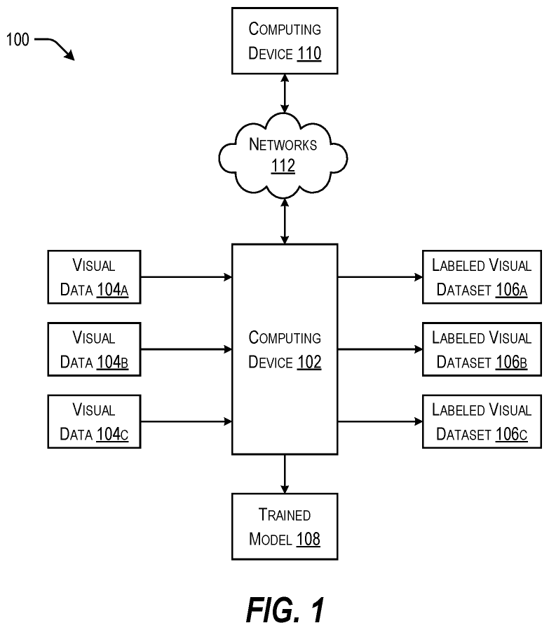

For context, FIG. 1 illustrates a diagram of an example environment 100 that can facilitate automated labeling of objects in visual data according to at least one embodiment of the present disclosure. The environment 100 can be embodied or implemented as a computing environment in which a computing device can label a previously unlabeled object depicted in visual data and then generate a labeled visual dataset based on such labeling. For example, the environment 100 can be embodied or implemented as a computing environment in which a computing device can label a previously unlabeled object one time and then automatically (without human intervention) label the same object once or multiple times in real-world visual data, synthetic visual data, or both, based on the initial labeling of the object.

In the example illustrated in FIG. 1, a computing device of the environment 100 can apply a ground truth label to an object one time and then automatically apply the ground truth label to the same object once or multiple times in one or more images, video frames of a video or a video stream, scans, or other visual data. In this way, the environment 100 can be implemented to automatically generate a training dataset of labeled visual data based on a single application of a ground truth label to an object depicted in, for example, an image, a video frame, a scan, or other visual data. The training dataset of labeled visual data can then be used to train a model to detect the object in various visual data.

In one example, the environment 100 can be embodied or implemented as an offline computing environment in which the above-described automated object labeling, training dataset generation, and model training can be performed by a computing device based on visual data depicting a scene having a previously unlabeled object. However, the labeling framework of the present disclosure is not limited to such an environment. In other examples, the environment 100 can be embodied or implemented as an online, real-time, online and offline hybrid, or near real-time computing environment in which at least one of a first or a second computing device can perform such operations based on previously captured or newly captured, real-time, or near real-time visual data depicting a scene having a previously unlabeled object.

As illustrated in the example depicted in FIG. 1, the environment 100 can include a computing device 102 that can receive or generate one or more visual data 104a, 104b, 104c. As described in further detail herein, the computing device 102 can generate at least one labeled visual dataset 106a, 106b, or 106c based on at least one of the visual data 104a, 104b, or 104c, respectively. The computing device 102 can also generate a trained model 108 based on any or all of the labeled visual datasets 106a, 106b, 106c.

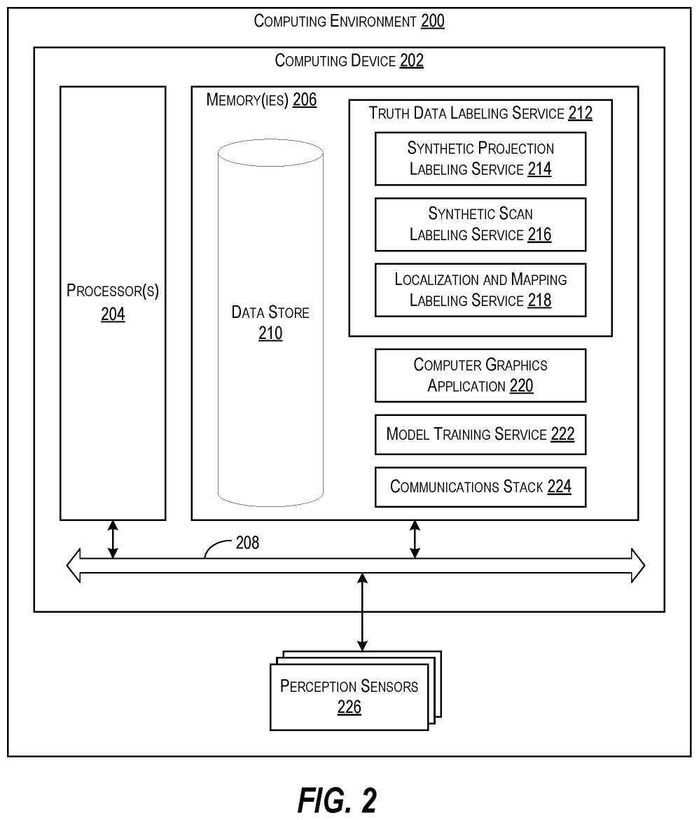

The computing device 102 can be embodied or implemented as, for example, a client computing device, a peripheral computing device, or both. The computing device 102, while described in the singular, may include a collection of computing devices 102. Examples of the computing device 102 can include a computer, a general-purpose computer, a special-purpose computer, a laptop, a tablet, a smartphone, another client computing device, or any combination thereof. In some cases, the computing device 102 can be operatively coupled, communicatively coupled, or both, to one or more perception sensors that can capture or generate any or all of the visual data 104a, 104b, 104c. For example, the computing device can be coupled to one or more of the perception sensors 226 described below with reference to FIG. 2, such as one or more image sensors or related systems, laser-based sensors or related systems, light detection and ranging (LiDAR) sensors or related systems, other types of sensors or systems, or combinations thereof.

The visual data 104a, 104b, 104c can each be indicative of or include at least one of image data, video data, scan data, or other visual data. Each of the visual data 104a, 104b, 104c can depict a scene having one or more unlabeled objects. The scene depicted in each of the visual data 104a, 104b, 104c can be the same scene. Similarly, the objects depicted in each of the visual data 104a, 104b, 104c can be the same objects. In some cases, one or more of the visual data 104a, 104b, 104c can depict at least one of a different scene or different objects compared to the other visual data 104a, 104b, 104c. Examples of an unlabeled object that can be depicted in any or all of the visual data 104a, 104b, 104c can include at least one of a vehicle, a building, a structure, a machine, a device, a person, an animal, a static object, a dynamic object, or another type of object.

The visual data 104a can be indicative of or include one or more images or video frames of a video or a video stream. The one or more images or video frames of a video or a video stream can be generated by a camera that can be included in or coupled to the computing device 102. Each of the images or video frames of the visual data 104a can be, for instance, a real-world 2D image or a real-world 2D video frame, respectively. For example, any or all of the images or video frames of the visual data 104a can depict a real-world scene having at least one real-world object. The visual data 104a can be rendered and annotated by the computing device 102 in a virtual environment. For instance, as described in further detail herein, the computing device 102 can implement a computer graphics application, such as a computer graphics animation application, to render and annotate any or all real-world 2D images or video frames of the visual data 104a in a virtual environment.

In particular, the computing device 102 implement one or more tools or features of a computer graphics application to perform one or more operations described herein with respect to any or all of the visual data 104a, 104b, 104c and the labeled visual datasets 106a, 106b, 106c. Example operations that can be performed by the computing device 102 using the tools and features of a computer graphics application can include at least one of visual data generation, rendering, annotation, and modification, raster graphics editing, digital drawing, 3D modeling, animation, simulation, texturing, UV mapping, UV unwrapping, rigging and skinning, compositing, sculpting, match moving, motion graphics, video editing, or another operation. To perform any or all of such operations, the computing device 102 can access an application programming interface (API) associated with the computer graphics application to programmatically perform various actions in at least one of a viewport or a render engine of the computer graphics application. In some cases, the API can be a python-based API.

The visual data 104b can be indicative of or include a scan that can be generated by a scanner. For example, the scan can be a LiDAR scan that can be generated by a LiDAR scanner that can be included in or coupled to the computing device 102. The scan can be, for instance, a synthetic reconstruction of a real-world scene having at least one real-world object. For example, the scan can be a synthetic 3D reconstruction of a real-world scene having at least one real-world object. As described in further detail herein, the visual data 104b can be rendered and annotated by the computing device 102 in a virtual environment. For instance, the computing device 102 can implement the computer graphics application noted above to render and annotate the synthetic 3D reconstruction in a virtual environment.

The visual data 104c can be indicative of or include both a scan that can be generated by a scanner, such as a LiDAR scan that can be generated by a LiDAR scanner, and a video having a plurality of video frames that can be generated by a camera. Both the scan and the video of the visual data 104c can depict the same real-world scene having at least one real-world object. However, the scan can be a synthetic reconstruction of such a real-world scene and object, whereas the video can be a real-world video of such a real-world scene and object. For example, the scan can be a synthetic 3D reconstruction of such a real-world scene and object, whereas the video frames of the video can be real-world 2D video frames of such a real-world scene and object.

The scan can be generated by, for example, a LiDAR scanner that can be included in or coupled to the computing device 102. The video, and thus, the video frames can be generated by a camera that can be included in or coupled to the computing device 102. In one example, the computing device 102 can operate the LiDAR scanner and the camera concurrently to synchronously generate the scan and the video, respectively. In another example, the computing device 102 can operate the LiDAR scanner and the camera sequentially to asynchronously generate the scan and the video, respectively. In some cases, the computing device 102 can implement at least one of a SLAM algorithm or a SAM algorithm in conjunction with operating the scanner and the camera to correlate (e.g., map, associate, sync, match) the video frames of the video with the scan. For example, the computing device 102 can implement at least one of a SLAM algorithm or a SAM algorithm while simultaneously operating the scanner and the camera to correlate the video frames of the video with the scan.

The visual data 104c can be rendered and annotated by the computing device 102 in a virtual environment. For instance, as described in further detail herein, the computing device 102 can implement the computer graphics application noted above to render and annotate the synthetic 3D reconstruction from the scan portion of the visual data 104c in a virtual environment. The computing device 102 can also implement the computer graphics application to render and annotate any or all real-world 2D video frames from the video portion of the visual data 104c in the virtual environment.

The labeled visual datasets 106a, 106b, 106c can be indicative of or include one or more annotations of label data respectively applied to one or more objects depicted in any or all of the visual data 104a, 104b, 104c, respectively. The annotations of label data are also referred to herein as “label data annotations.” As described in further detail with reference to FIG. 2, the computing device 102 can implement one or more labeling methods of the present disclosure to respectively apply one or more label data annotations to one or more objects depicted in any or all of the visual data 104a, 104b, 104c. In this way, the computing device 102 can generate the labeled visual datasets 106a, 106b, 106c using the visual data 104a, 104b, 104c, respectively.

The labeled visual dataset 106a can be indicative of or include label data annotations that can be applied by the computing device 102 to respective objects depicted in any or all of the above-described real-world 2D images or video frames of the visual data 104a. In some cases, the computing device 102 can generate the labeled visual dataset 106a by implementing the computer graphics application noted above to project synthetic data onto one or more real-world objects depicted in any or all of such real-world 2D images or video frames of the visual data 104a. For instance, the computing device 102 can project synthetic data indicative of a ground truth label onto one of such real-world objects one time and then project the synthetic data onto the same object once or multiple times in one or more real-world 2D images or video frames of the visual data 104a.

In one example, the computing device 102 can implement the computer graphics application using the real-world 2D images or video frames of the visual data 104a as input. The real-world 2D images or video frames can be generated by a camera that can be included with or coupled to the computing device 102. The real-world 2D images or video frames can depict a real-world scene having real world objects. The computing device 102 can use the computer graphics application to generate a virtual environment that can include a virtual representation of the real-world scene and objects based on the real-world 2D images or video frames of the visual data 104a. The virtual representation can include one or more virtual objects that respectively correspond to one or more real-world objects in the real-world scene.

In some cases, the computing device 102 can implement the computer graphics application to generate at least one of the virtual environment, the virtual representation of the real-world scene, or the virtual objects corresponding to the real-world objects based on input data received from a user implementing the computing device 102. For example, the computing device 102 can generate a virtual object that corresponds to a particular real-world object in the real-world scene based on receiving input data that is indicative of a selection of the real-world object for label data annotation. The computing device 102 can receive such input data from a user implementing the computing device 102. The computing device 102 can receive the input data by way of at least one of an input device or an interface component that can be included with or coupled to the computing device 102 such as, for instance, a keyboard or a mouse and/or a graphical user interface (GUI), respectively.

In some cases, the input data described above can also be indicative of or include a ground truth label that can be provided by the user. The ground truth label can be indicative of and correspond to the real-world object depicted in the real-world 2D images or video frames. Based on receiving the input data that can be indicative of or include at least one of a selection of a particular real-world object for label data annotation or a ground truth label corresponding to such an object, the computing device 102 can implement the computer graphics application to generate a virtual object that corresponds to and is representative of the object.

In other cases, the computing device 102 can implement at least one of an ML model, an AI model, or another model to predict the ground truth label using a supervised labeling process or an unsupervised labeling process. For example, the computing device 102 can implement at least one of a neural network (NN), a convolutional neural network (CNN), a you only look once (YOLO) model, a classifier model, or another type of model to predict the ground truth label using a supervised labeling process or an unsupervised labeling process. In cases where the model is implemented using a supervised labeling process, the ground truth label prediction output by such a model can then be verified or rejected by a user by way of the input device and/or interface component described above that can be associated with the computing device 102. Based on obtaining the ground truth label output by a model or verified by a user, the computing device 102 can implement the computer graphics application to generate a virtual object that corresponds to and is representative of a particular real-world object that has been selected for label data annotation.

Based on receiving the input data, obtaining the ground truth label, and generating the virtual object, the computing device 102 can further implement the computer graphics application to project the virtual object in front of the real-world object depicted in one of the real-world 2D images or video frames. The computing device 102 can then implement the computer graphics application to raster the projection of the virtual object in front of the real-world object depicted in the real-world 2D image or video frame, thereby creating a raster projection image. The computing device 102 can further use the computer graphics application to temporarily remove the real-world 2D image or video frame and the virtual object from the virtual environment while preserving the location of the virtual object with respect to at least one of the raster projection image or the real-world 2D image or video frame.

By temporarily removing the real-world 2D image or video frame and the virtual object from the virtual environment as described above, the computing device 102 can thereby create a mask (mask layer) based on the raster projection image. The mask can include at least one of a raster image that corresponds to the virtual object and the real-world object or a sub-raster image that corresponds to a portion of the virtual object or the real-world object. Once the mask is created, the computing device 102 can further implement the computer graphics application to apply at least one of label data or one or more label data annotations to at least one of the raster image or the sub-raster image. For instance, the computing device 102 can apply at least one of label data or one or more label data annotations directly to at least one of the raster image or the sub-raster image depicted in the mask.

In one example, the computing device 102 can apply a boundary annotation along edges of at least one of the raster image or the sub-raster image. In another example, the computing device 102 can generate a bounding box around at least one of the raster image or the sub-raster image. In another example, the computing device 102 can associate metadata that is indicative of the real-world object with at least one of the raster image, the sub-raster image, the boundary annotation, or the bounding box. For instance, the computing device 102 can encode at least one of the raster image, the sub-raster image, the boundary annotation, or the bounding box with metadata that is indicative of the ground truth label that can be obtained by the computing device 102 via the input data or a model as described above. The ground truth label can be indicative of or include, for example, at least one of a ground truth classification or a ground truth classification label.

Once labeled, the raster image can be indicative of a labeled raster image corresponding to the virtual object and the real-world object. Similarly, once labeled, the sub-raster image can be indicative of a labeled sub-raster image corresponding to a portion of the virtual object and the real-world object. The computing device 102 can then implement the computer graphics application to segment the mask so as to extract at least one of the labeled raster image or the labeled sub-raster image. Once extracted, the computing device 102 can further use the computer graphics application to respectively transfer at least one of the labeled raster image or the labeled sub-raster image onto at least one of the real-world object or a portion of the real-world object depicted in the real-world 2D image or video frame of the visual data 104a.

The computing device 102 can further implement the computer graphics application to automatically repeat the above-described labeling process once or multiple times with respect to one or multiple positions and/or rotations of at least one of the virtual representation of the real-world scene or the virtual object corresponding to the real-world object. For example, the computing device 102 can automatically create multiple masks that each depict a different labeled raster image corresponding to the virtual object as viewed from a different position and/or rotation within the virtual environment. For instance, each different position and/or rotation can correspond to a different vantage point of a virtual camera associated with the virtual environment. In particular, a virtual camera associated with the computer graphics application noted above.

After creating the multiple masks described above, the computing device 102 can then automatically segment each of the masks to extract and transfer one or more of the different labeled raster images to one or more real-world 2D images or video frames of the visual data 104a. For instance, the computing device 102 can respectively transfer different labeled raster images to various real-world 2D images or video frames of the visual data 104a, thereby generating the labeled visual dataset 104a. In this way, the computing device 102 can automatically generate the labeled visual dataset 106a such that it can be indicative of or include label data annotations that are applied to real-world imagery.

The labeled visual dataset 106b can be indicative of or include label data annotations that can be applied by the computing device 102 to respective objects depicted in the above-described synthetic 3D reconstruction in the visual data 104b. In some cases, the computing device 102 can generate the labeled visual dataset 106b by implementing the computer graphics application noted above to project synthetic data onto at least one of the synthetic 3D reconstruction or one or more synthetic 2D images that can be generated based on the synthetic 3D reconstruction. For instance, the computing device 102 can perform a single projection of synthetic data indicative of a ground truth label onto a portion of the synthetic 3D reconstruction that corresponds to a real-world object and then automatically perform one or more additional projections of the synthetic data onto the same portion of the 3D reconstruction depicted in such one or more synthetic 2D images.

In one example, the computing device 102 can implement the computer graphics application using a textured LiDAR scan from the visual data 104b as input. The textured LiDAR scan can be generated by a LiDAR scanner that can be included with or coupled to the computing device 102. The LiDAR scan can be a synthetic 3D reconstruction of a real-world scene having real world objects. The computing device 102 can then use the computer graphics application to generate a virtual environment that can include the synthetic 3D reconstruction of the real-world scene and objects depicted in the textured LiDAR scan.

Using the computer graphics application, the computing device 102 can then generate a 3D point cloud (i.e., 3D point cloud data or data points) in the virtual environment such that the 3D point cloud corresponds to the synthetic 3D reconstruction of the real-world scene and objects. The 3D point cloud can be indicative of a virtual representation of the real-world scene and objects. Additionally, a subset of the 3D point cloud (i.e., a subset of 3D cloud data or data points) can be indicative of a virtual representation subset that corresponds to and is representative of a real-world object in the real-world scene. The subset of the 3D point cloud is also referred to herein as a “3D point cloud subset.”

The computing device 102 can then use the computer graphics application to extract or isolate the 3D point cloud subset (the virtual representation subset) from the 3D point cloud (the virtual representation) for automated label data annotation. In one example, the computing device 102 can automatically extract or isolate and further annotate the 3D point cloud subset based on receiving input data. The input data can be indicative of a selection of a particular real-world object for automated label data annotation. For instance, the input data can be indicative of a selection of at least one of the real-world object depicted in the synthetic 3D reconstruction or the 3D point cloud subset for automated label data annotation. The computing device 102 can receive such input data from a user as described above, for example, by way of at least one of a keyboard, a mouse, or a GUI that can be included with or coupled to the computing device 102.

In some cases, the input data described above can also be indicative of or include a ground truth label that can be provided by the user. The ground truth label can be indicative of and correspond to the real-world object depicted in at least one of the synthetic 3D reconstruction or one or more synthetic 2D images that can be generated based on the synthetic 3D reconstruction. Based on receiving the input data that can be indicative of or include at least one of a selection of a particular real-world object for automated label data annotation or a ground truth label corresponding to such an object, the computing device 102 can implement the computer graphics application to automatically extract or isolate the 3D point cloud subset for automated label data annotation.

In other cases, the computing device 102 can implement at least one of an ML model, an AI model, or another model to predict the ground truth label using a supervised labeling process or an unsupervised labeling process. For example, the computing device 102 can implement at least one of an NN, a CNN, a YOLO model, a classifier model, or another type of model to predict the ground truth label using a supervised labeling process or an unsupervised labeling process. In cases where the model is implemented using a supervised labeling process, the ground truth label prediction output by such a model can then be verified or rejected by a user by way of the input device and/or interface component described above that can be associated with the computing device 102. Based on obtaining the ground truth label output by a model or verified by a user, the computing device 102 can implement the computer graphics application to automatically extract or isolate the 3D point cloud subset for automated label data annotation.

Based on receiving the input data, obtaining the ground truth label, and generating the 3D point cloud subset, the computing device 102 can further implement the computer graphics application to project the 3D point cloud subset in front of the real-world object depicted in the synthetic 3D reconstruction. The computing device 102 can then implement the computer graphics application to temporarily remove the synthetic 3D reconstruction from the virtual environment while preserving the location of the 3D point cloud subset with respect to the synthetic 3D reconstruction.

By temporarily removing the synthetic 3D reconstruction from the virtual environment as described above, the computing device 102 can thereby create a mask (mask layer) that can include the 3D point cloud subset. Once the mask is created, the computing device 102 can then use the computer graphics application to automatically apply at least one of label data or one or more label data annotations to the 3D point cloud subset. For instance, the computing device 102 can automatically apply at least one of label data or one or more label data annotations directly to the 3D point cloud subset depicted in the mask.

In one example, the computing device 102 can apply a vertex annotation along vertices of the 3D point cloud subset. In another example, the computing device 102 can generate a bounding box around the 3D point cloud subset. In another example, the computing device 102 can associate metadata that is indicative of the object with at least one of the 3D point cloud subset, the vertex annotation, or the bounding box. For instance, the computing device 102 can encode at least one of the 3D point cloud subset, the vertex annotation, or the bounding box with metadata that is indicative of the ground truth label that can be obtained by the computing device 102 via the input data or a model as described above. The ground truth label can be indicative of or include, for example, at least one of a ground truth classification or a ground truth classification label.

Once labeled, the 3D point cloud subset (the virtual representation subset) can be indicative of a labeled virtual representation subset and a labeled 3D point cloud subset that can each correspond to the real-world object depicted in the synthetic 3D reconstruction. The computing device 102 can then implement the computer graphics application to segment the mask so as to extract the labeled 3D point cloud subset. Once extracted, the computing device 102 can further use the computer graphics application to overlay or project the labeled 3D point cloud subset onto at least one of the synthetic 3D reconstruction or one or more synthetic 2D images that can be generated based on the synthetic 3D reconstruction. For instance, the computing device 102 can use the computer graphics application to generate one or more synthetic 2D images of the synthetic 3D reconstruction that can include the labeled 3D point cloud subset overlaid or projected onto the real-world object depicted in the synthetic 3D reconstruction. In some cases, to generate such one or more synthetic 2D images of the synthetic 3D reconstruction, the computing device 102 can perform at least one of a UV mapping or UV unwrapping operation using the computer graphics application, an API associated with the computer graphics application, or both.

In one example, to generate such one or more synthetic 2D images, the computing device 102 can further implement the computer graphics application to automatically repeat the above-described labeling process once or multiple times with respect to one or multiple positions and/or locations of the 3D point cloud subset corresponding to the real-world object depicted in the synthetic 3D reconstruction. For example, the computing device 102 can automatically create multiple masks that each depict a different labeled 3D point cloud subset corresponding to the 3D point cloud subset as viewed from a different position and/or location within the virtual environment. For instance, each different position and/or location can correspond to a different vantage point of a virtual camera associated with the virtual environment and the computer graphics application. After creating the multiple masks described above, the computing device 102 can then use the computer graphics application to automatically segment each of the masks to respectively extract and transfer the different labeled 3D point cloud subsets to the one or more synthetic 2D images.

In this way, the computing device 102 can automatically generate multiple synthetic 2D images that depict different projections of the labeled 3D point cloud subset onto the real-world object depicted in the synthetic 3D reconstruction. The multiple synthetic 2D images can depict different projections of the labeled 3D point cloud subset onto the real-world object as viewed from different angles and locations within the virtual environment. For instance, the multiple synthetic 2D images can depict different projections of the labeled 3D point cloud subset onto the real-world object as viewed from different vantage points of the virtual camera.

The labeled visual dataset 106b can be indicative of or include the synthetic 2D images described above that can depict different projections of the labeled 3D point cloud subset onto the real-world object depicted in the synthetic 3D reconstruction as viewed from various vantage points of the virtual camera. In this way, the computing device 102 can automatically generate the labeled visual dataset 106b such that it can be indicative of or include label data annotations that are applied to synthetic imagery.

The labeled visual dataset 106c can be indicative of or include label data annotations that can be applied by the computing device 102 to respective objects depicted in one or more real-world 2D video frames of a video in the visual data 104c. In some cases, the computing device 102 can generate the labeled visual dataset 106c by implementing the computer graphics application noted above to project synthetic data onto any or all of the real-world 2D video frames.

In some examples, the computing device 102 can perform a single projection of synthetic data indicative of a ground truth label onto a portion of the synthetic 3D reconstruction that corresponds to a real-world object and then automatically perform one or more additional projections of the synthetic data onto the real-world object depicted in one or more of the real-world 2D video frames. In other examples, the computing device 102 can perform a single projection of synthetic data indicative of a ground truth label onto a real-world object depicted in a real-world 2D video frame of a video and then automatically perform one or more additional projections of the synthetic data onto the real-world object depicted in one or more other real-world 2D video frames of the video.

In one example, the computing device 102 can implement the computer graphics application using a scan and a video from the visual data 104c as input. The scan can be a LiDAR scan. Both the scan and the video can depict the same real-world scene having at least one real-world object. However, the scan can be a synthetic reconstruction of such a real-world scene and object, while the video can be a real-world video of such a real-world scene and object. For example, the scan can be a synthetic 3D reconstruction of such a real-world scene and object, while the video frames of the video can be real-world 2D video frames of such a real-world scene and object.

As described above, the scan can be generated by a scanner such as, for example, a LiDAR scanner that can be included in or coupled to the computing device 102. The video, and thus, the video frames can be generated by a camera that can be included in or coupled to the computing device 102. In one example, the computing device 102 can operate the scanner and the camera concurrently to synchronously generate the scan and the video, respectively. In another example, the computing device 102 can operate the scanner and the camera sequentially to asynchronously generate the scan and the video, respectively.

Additionally, in one example, the computing device 102 can implement a SLAM algorithm in conjunction with operating the scanner and the camera to correlate (e.g., map, associate, sync, match) the video frames of the video with the scan. For instance, the computing device 102 can implement a SLAM algorithm, such as a LiDAR-inertial odometry SLAM (LIO-SLAM) algorithm, while simultaneously operating the scanner and the camera to correlate the real-world 2D video frames of the video with the synthetic 3D reconstruction of the scan. In another example, the computing device 102 can implement a SAM algorithm in conjunction with operating the scanner and the camera to correlate (e.g., map, associate, sync, match) the video frames of the video with the scan. For instance, the computing device 102 can implement a SAM algorithm, such as a LiDAR-inertial odometry SAM (LIO-SAM) algorithm, while simultaneously operating the scanner and the camera to correlate the real-world 2D video frames of the video with the synthetic 3D reconstruction of the scan.

The computing device 102 can use the computer graphics application noted above to generate a virtual environment that can include the synthetic 3D reconstruction of the real-world scene and objects depicted in the scan and the video. Using the computer graphics application, the computing device 102 can then generate a 3D point cloud (i.e., 3D point cloud data or data points) in the virtual environment such that the 3D point cloud corresponds to the real-world scene and objects depicted in the synthetic 3D reconstruction and the real-world 2D video frames. The 3D point cloud can be indicative of a virtual representation of the real-world scene and objects. Additionally, a subset of the 3D point cloud (i.e., a subset of 3D cloud data or data points) can be indicative of a virtual representation subset that corresponds to and is representative of a real-world object in the real-world scene. As noted above, the subset of the 3D point cloud is also referred to herein as a “3D point cloud subset.”

In one example, the computing device 102 can use the computer graphics application to generate the virtual representation (the 3D point cloud) of the real-world scene and the virtual representation subset (the 3D point cloud subset) corresponding to the real-world object based on implementing at least one of a SLAM algorithm or a SAM algorithm in conjunction with the scanner and the camera. For example, the computing device 102 can apply at least one of a SLAM algorithm or a SAM algorithm to the scan as it is being generated by the scanner and while the video is being generated by the camera. In this way, the computing device 102 can generate the virtual representation and the virtual representation subset while simultaneously tracking 3D location data corresponding to at least one of the real-world object depicted in the synthetic 3D reconstruction or the virtual representation subset (the 3D point cloud subset) with respect to at least one vantage point of a virtual camera associated with the virtual environment and the computer graphics application.

In some cases, the computing device 102 can implement the computer graphics application using such tracked 3D location data to generate the virtual environment described above that can include the synthetic 3D reconstruction of the real-world scene and objects depicted in the scan and the video. For example, the computing device 102 can use the tracked 3D location data to generate the virtual representation (the 3D point cloud) of the real-world scene and the virtual representation subset (the 3D point cloud subset) that corresponds to the real-world object.

To generate such a virtual dataset using the tracked 3D location data, the computing device 102 can correlate the scanner with the camera and the virtual camera. For example, the computing device 102 can correlate pose data corresponding to the scanner with pose data respectively corresponding to the camera and the virtual camera. Based on such correlation, the computing device 102 can implement the computer graphics application using the tracked 3D location data to generate the virtual dataset including the virtual representation (the 3D point cloud) of the real-world scene and the virtual representation subset (the 3D point cloud subset) that corresponds to the real-world object. By tracking the 3D location data and/or correlating the scanner with the camera and the virtual camera, the computing device 102 can effectively allow for the real-world 2D video frames to be synced with at least one of the synthetic 3D reconstruction or the 3D point cloud such that the real-world 2D video frames can be overlaid onto at least one of the synthetic 3D reconstruction or the 3D point cloud, respectively.

In one example, the computing device 102 can implement the computer graphics application using such tracked 3D location to automatically apply one or more label data annotations to a real-world object depicted in any or all of the real-world 2D video frames. To automatically apply such one or more label data annotations based the tracked 3D location data, the computing device 102 can correlate the scanner with the camera and the virtual camera. For example, the computing device 102 can correlate pose data corresponding to the scanner with pose data respectively corresponding to the camera and the virtual camera. In one example, based on such correlation, the computing device 102 can implement the computer graphics application using the tracked 3D location data to automatically apply one or more label data annotations to the real-world object depicted in any or all of the real-world 2D video frames.

To correlate such pose data noted above, the computing device 102 can map time series pose data of the scanner to time series pose data respectively corresponding to the camera and the virtual camera. The time series pose data can be time series pose data respectively corresponding to the scanner, the camera, and the virtual camera while the scanner is generating the scan, the camera is generating the video, and at least one of a SLAM algorithm or a SAM algorithm is tracking the 3D location data of the real-world object and/or the virtual representation subset (the 3D point cloud subset) as described above. In some cases, to correlate such pose data or time series pose data noted above, the computing device 102 can perform a match moving operation using the computer graphics application, an API associated with the computer graphics application, or both.

In some examples, based on correlating the scanner with the camera and the virtual camera as described above, the computing device 102 can implement the computer graphics application to extract or isolate the 3D point cloud subset (the virtual representation subset) from the 3D point cloud (the virtual representation) for automated label data annotation. In one example, the computing device 102 can automatically extract or isolate and further annotate the 3D point cloud subset based on receiving input data. The input data can be indicative of a selection of a particular real-world object for automated label data annotation. For instance, the input data can be indicative of at least one of a selection of the real-world object depicted in the synthetic 3D reconstruction, a selection of the 3D point cloud subset, or a selection of the real-world object depicted in the real-world 2D video frames. The computing device 102 can receive such input data from a user as described above, for example, by way of at least one of a keyboard, a mouse, or a GUI that can be included with or coupled to the computing device 102.

In some cases, the input data described above can also be indicative of or include a ground truth label that can be provided by the user. The ground truth label can be indicative of and correspond to the real-world object depicted in at least one of the synthetic 3D reconstruction or one or more of the real-world 2D video frames. Based on receiving the input data that can be indicative of or include at least one of a selection of a particular real-world object for automated label data annotation or a ground truth label corresponding to such an object, the computing device 102 can implement the computer graphics application to automatically extract or isolate the 3D point cloud subset for automated label data annotation.

In other cases, the computing device 102 can implement at least one of an ML model, an AI model, or another model to predict the ground truth label using a supervised labeling process or an unsupervised labeling process. For example, the computing device 102 can implement at least one of an NN, a CNN, a YOLO model, a classifier model, or another type of model to predict the ground truth label using a supervised labeling process or an unsupervised labeling process. In cases where the model is implemented using a supervised labeling process, the ground truth label prediction output by such a model can then be verified or rejected by a user by way of the input device and/or interface component described above that can be associated with the computing device 102. Based on obtaining the ground truth label output by a model or verified by a user, the computing device 102 can implement the computer graphics application to automatically extract or isolate the 3D point cloud subset for automated label data annotation.

Based on performing the above-described correlation process, receiving the input data, obtaining the ground truth label, and generating the 3D point cloud subset, the computing device 102 can further implement the computer graphics application to project the 3D point cloud subset in front of the real-world object depicted in the synthetic 3D reconstruction. The computing device 102 can then implement the computer graphics application to temporarily remove the synthetic 3D reconstruction from the virtual environment while preserving the location of the 3D point cloud subset with respect to the synthetic 3D reconstruction.

By temporarily removing the synthetic 3D reconstruction from the virtual environment as described above, the computing device 102 can thereby create a mask (mask layer) that can include the 3D point cloud subset. Once the mask is created, the computing device 102 can then use the computer graphics application to automatically apply at least one of label data or one or more label data annotations to the 3D point cloud subset. For instance, the computing device 102 can automatically apply at least one of label data or one or more label data annotations directly to the 3D point cloud subset depicted in the mask. In some cases, the mask creation process described above may be eliminated based on correlating the scanner with the camera and the virtual camera as described above. In this way, the computing device 102 use the computer graphics application to automatically apply label data annotations directly onto the real-world object depicted in one or more of the real-world 2D video frames of the video in the visual data 104c.

In one example, the computing device 102 can apply a vertex annotation along vertices of the 3D point cloud subset. In another example, the computing device 102 can generate a bounding box around the 3D point cloud subset. In another example, the computing device 102 can associate metadata that is indicative of the object with at least one of the 3D point cloud subset, the vertex annotation, or the bounding box. For instance, the computing device 102 can encode at least one of the 3D point cloud subset, the vertex annotation, or the bounding box with metadata that is indicative of the ground truth label that can be obtained by the computing device 102 via the input data or a model as described above. The ground truth label can be indicative of or include, for example, at least one of a ground truth classification or a ground truth classification label.

Once labeled, the 3D point cloud subset (the virtual representation subset) can be indicative of a labeled virtual representation subset and a labeled 3D point cloud subset that can each correspond to the real-world object depicted in the synthetic 3D reconstruction and the real-world 2D video frames. In some cases, the computing device 102 can then implement the computer graphics application to segment the mask so as to extract the labeled 3D point cloud subset. Once extracted, the computing device 102 can further use the computer graphics application to overlay or project the labeled 3D point cloud subset onto at least one of the synthetic 3D reconstruction or one or more of the real-world 2D video frames. In other cases where the mask may be eliminated, based on correlating the scanner with the camera and the virtual camera as described above, the computing device 102 can use the computer graphics application to sync the video with the scan so as to overlay the real-world 2D video frames onto at least one of the synthetic 3D reconstruction or the 3D point cloud. The computing device 102 can then use the computer graphics application to overlay or project the labeled 3D point cloud subset directly onto the real-world object depicted in one or more of the real-world 2D video frames.

The labeled visual dataset 106c can be indicative of or include one or more of the real-world 2D video frames described above that can depict one or more projections of the labeled 3D point cloud subset directly onto the real-world object depicted in one or more of the real-world 2D video frames. In this way, the computing device 102 can automatically generate the labeled visual dataset 106c such that it can be indicative of or include label data annotations that are applied to real-world imagery.

As noted above, the computing device 102 can also generate the trained model 108 based on any or all of the labeled visual datasets 106a, 106b, 106c. For instance, the computing device 102 can train at least one of an ML model, an AI model, or another model using at least one of the labeled visual datasets 106a, 106b, 106c. In this way, the computing device 102 can generate the trained model 108 using a training dataset having label data annotations applied to respective objects depicted in real-world imagery, synthetic imagery, or both.

In one example, to generate the trained model 108, the computing device 102 can use any or all of the labeled visual datasets 106a, 106b, 106c to train an object detection model that can then be implemented to detect and classify objects in various visual data. For instance, the computing device 102 can use any or all of the labeled visual datasets 106a, 106b, 106c to train at least one of an NN, a CNN, a YOLO model, a classifier model, or another type of model. Once trained, the computing device 102 can implement the trained model 108 to detect one or more particular objects depicted in various visual data as described below.

The computing device 102 can train at least one of an ML model, an AI model, or another model to detect a particular object that has been annotated with label data in any or all of the labeled visual datasets 106a, 106b, 106c as described above and is also depicted in various visual data other than the visual data 104a, 104b, 104c and the labeled visual datasets 106a, 106b, 106c. Once trained, the trained model 108 can be implemented to detect such an object in various visual data that depict various scenes. The various scenes can be different from or the same as one or more scenes depicted in any or all of the visual data 104a, 104b, 104c. The various scenes can also be different from or the same as one or more scenes depicted in any or all of the labeled visual datasets 106a, 106b, 106c.

As illustrated in the example depicted in FIG. 1, the environment 100 can further include a computing device 110. The computing device 110 can be communicatively coupled, operatively coupled, or both, to the computing device 102 by way of one or more networks 112 (hereinafter, “the networks 112”). The computing device 110 can be embodied or implemented as, for instance, a server computing device, a virtual machine, a supercomputer, a quantum computer or processor, another type of computing device, or any combination thereof. Alternatively, in some examples, the computing device 110 can be embodied or implemented as a client or peripheral computing device such as, for instance, a computer, a general-purpose computer, a special-purpose computer, a laptop, a tablet, a smartphone, another client computing device, or any combination thereof.

The networks 112 can include, for instance, the Internet, intranets, extranets, wide area networks (WANs), local area networks (LANs), wired networks, wireless networks (e.g., cellular, WiFi®), cable networks, satellite networks, other suitable networks, or any combinations thereof. The computing device 102 and the computing device 110 can communicate data with one another over the networks 112 using any suitable systems interconnect models and/or protocols. Example interconnect models and protocols include dedicated short-range communications (DSRC), hypertext transfer protocol (HTTP), simple object access protocol (SOAP), representational state transfer (REST), real-time transport protocol (RTP), real-time streaming protocol (RTSP), real-time messaging protocol (RTMP), user datagram protocol (UDP), internet protocol (IP), transmission control protocol (TCP), and/or other protocols for communicating data over the networks 112, without limitation. Although not illustrated, the networks 112 can also include connections to any number of other network hosts, such as website servers, file servers, networked computing resources, databases, data stores, or other network or computing architectures in some cases.

The computing device 110 can implement one or more aspects of the labeling framework of the present disclosure. For example, in some cases, the computing device 102 can offload at least some of its processing workload to the computing device 110 via the networks 112. For instance, the computing device 102 can send at least one of the visual data 104a, 104b, 104c to the computing device 110 using the networks 112. The computing device 110 can then implement one or more of the labeling methods described herein to generate at least one of the labeled visual datasets 106a, 106b, 106c using at least one of the visual data 104a, 104b, 104c, respectively.

In another example, the computing device 102 can send one or more of the labeled visual datasets 106a, 106b, 106c to the computing device 110 using the networks 112. The computing device 110 can then generate the trained model 108 in the same manner as the computing device 102 can generate the trained model 108. For example, the computing device 110 can use any or all of the labeled visual datasets 106a, 106b, 106c to train a model to detect one or more particular objects depicted in various visual data. Once trained, the computing device 110 can implement the trained model 108 to detect a particular object depicted in various visual data that depict various scenes. The various scenes can be different from or the same as one or more scenes depicted in any or all of the visual data 104a, 104b, 104c. The various scenes can also be different from or the same as one or more scenes depicted in any or all of the labeled visual datasets 106a, 106b, 106c.

In another example, the computing device 102 can send the trained model 108 to the computing device 110 using the networks 112. The computing device 110 can then implement the trained model 108 to detect one or more particular objects depicted in various visual data other than the visual data 104a, 104b, 104c and the labeled visual datasets 106a, 106b, 106c as described above.

FIG. 2 illustrates a block diagram of an example computing environment 200 that can facilitate automated labeling of objects in visual data according to at least one embodiment of the present disclosure. The computing environment 200 can include or be coupled (e.g., communicatively, operatively) to a computing device 202. With reference to FIGS. 1 and 2 collectively, the computing environment 200 can be used, at least in part, to embody or implement one or more components of the environment 100. Additionally, the computing device 202 can be used, at least in part, to embody or implement at least one of the computing device 102 or the computing device 110.

The computing device 202 can include at least one processing system, for example, having at least one processor 204 and at least one memory 206, both of which can be coupled (e.g., communicatively, electrically, operatively) to a local interface 208. The memory 206 can include a data store 210, a truth data labeling service 212, a synthetic projection labeling service 214, a synthetic scan labeling service 216, a localization and mapping labeling service 218, a computer graphics application 220, a model training service 222, and a communications stack 224 in the example shown. The computing device 202 can also be coupled (e.g., communicatively, electrically, operatively) by way of the local interface 208 to one or more perception sensors 226 (hereinafter, “the perception sensors 226”). The computing environment 200 and the computing device 202 can also include other components that are not illustrated in FIG. 2. In some cases, the perception sensors 226 can be implemented, at least in part, as one or more functional modules of the computing device 202, similar to the truth data labeling service 212, the synthetic projection labeling service 214, the synthetic scan labeling service 216, the localization and mapping labeling service 218, the computer graphics application 220, and the model training service 222.

In some cases, the computing environment 200, the computing device 202, or both may or may not include all the components illustrated in FIG. 2. For example, in some cases, depending on how the computing environment 200 is embodied or implemented, the computing environment 200 may or may not include the perception sensors 226, and thus, the computing device 202 may or may not be coupled to the perception sensors 226. Also, in some cases, depending on how the computing device 202 is embodied or implemented, the memory 206 may or may not include at least one of the truth data labeling service 212, the synthetic projection labeling service 214, the synthetic scan labeling service 216, the localization and mapping labeling service 218, the computer graphics application 220, the model training service 222, or other components.

For instance, in an embodiment where the computing device 102 offloads its entire truth data labeling, training dataset generation, and model training processing workload to the computing device 110, the computing device 102 may not include at least one of the truth data labeling service 212, the synthetic projection labeling service 214, the synthetic scan labeling service 216, the localization and mapping labeling service 218, the computer graphics application 220, or the model training service 222. Conversely, in an embodiment where the computing device 102 does not offload any of its truth data labeling, training dataset generation, and model training processing workload to the computing device 110, the computing device 110 may not include at least one of the truth data labeling service 212, the synthetic projection labeling service 214, the synthetic scan labeling service 216, the localization and mapping labeling service 218, the computer graphics application 220, or the model training service 222.

The processor 204 can include any processing device (e.g., a processor core, a microprocessor, an application specific integrated circuit (ASIC), a field-programmable gate array (FPGA), a controller, a microcontroller, or a quantum processor) and can include one or multiple processors that can be operatively connected. In some examples, the processor 204 can include one or more complex instruction set computing (CISC) microprocessors, one or more reduced instruction set computing (RISC) microprocessors, one or more very long instruction word (VLIW) microprocessors, or one or more processors that are configured to implement other instruction sets.

The memory 206 can be embodied as one or more memory devices and store data and software or executable-code components executable by the processor 204. For example, the memory 206 can store executable-code components associated with the truth data labeling service 212, the synthetic projection labeling service 214, the synthetic scan labeling service 216, the localization and mapping labeling service 218, the computer graphics application 220, the model training service 222, and the communications stack 224 for execution by the processor 204. The memory 206 can also store data such as the data described below that can be stored in the data store 210, among other data. For instance, the memory 206 can also store the visual data 104a, 104b, 104c, the labeled visual datasets 106a, 106b, 106c, the SLAM algorithm and/or the SAM algorithm described herein (e.g., the LIO-SLAM algorithm and/or the LIO-SAM algorithm), one or more of the ML and/or AI models described herein, the trained model 108, or any combination thereof.

The memory 206 can store other executable-code components for execution by the processor 204. For example, an operating system can be stored in the memory 206 for execution by the processor 204. Where any component discussed herein is implemented in the form of software, any one of a number of programming languages can be employed such as, for example, C, C++, C #, Objective C, JAVA®, JAVASCRIPT®, Perl, PHP, VISUAL BASIC®, PYTHON®, RUBY, FLASH®, or other programming languages.

As discussed above, the memory 206 can store software for execution by the processor 204. In this respect, the terms “executable” or “for execution” refer to software forms that can ultimately be run or executed by the processor 204, whether in source, object, machine, or other form. Examples of executable programs include, for instance, a compiled program that can be translated into a machine code format and loaded into a random access portion of the memory 206 and executed by the processor 204, source code that can be expressed in an object code format and loaded into a random access portion of the memory 206 and executed by the processor 204, source code that can be interpreted by another executable program to generate instructions in a random access portion of the memory 206 and executed by the processor 204, or other executable programs or code.

The local interface 208 can be embodied as a data bus with an accompanying address/control bus or other addressing, control, and/or command lines. In part, the local interface 208 can be embodied as, for instance, an on-board diagnostics (OBD) bus, a controller area network (CAN) bus, a local interconnect network (LIN) bus, a media oriented systems transport (MOST) bus, ethernet, or another network interface.

The data store 210 can include data for the computing device 202 such as, for instance, one or more unique identifiers for the computing device 202, digital certificates, encryption keys, session keys and session parameters for communications, and other data for reference and processing. The data store 210 can also store computer-readable instructions for execution by the computing device 202 via the processor 204, including instructions for the truth data labeling service 212, the synthetic projection labeling service 214, the synthetic scan labeling service 216, the localization and mapping labeling service 218, the computer graphics application 220, the model training service 222, and the communications stack 224. In some cases, the data store 210 can also store the visual data 104a, 104b, 104c, the labeled visual datasets 106a, 106b, 106c, the SLAM algorithm and/or the SAM algorithm described herein (e.g., the LIO-SLAM algorithm and/or the LIO-SAM algorithm), one or more of the ML and/or AI models described herein, the trained model 108, or any combination thereof.

The truth data labeling service 212 can be embodied as one or more software applications or services executing on the computing device 202. For example, the truth data labeling service 212 can be embodied as and can include at least one of the synthetic projection labeling service 214, the synthetic scan labeling service 216, the localization and mapping labeling service 218, or another module. The truth data labeling service 212 can be executed by the processor 204 to implement at least one of the synthetic projection labeling service 214, the synthetic scan labeling service 216, or the localization and mapping labeling service 218. Each of the synthetic projection labeling service 214, the synthetic scan labeling service 216, and the localization and mapping labeling service 218 can also be respectively embodied as one or more software applications or services executing on the computing device 202. In one example, the truth data labeling service 212 can be executed by the processor 204 to generate the labeled visual datasets 106a, 106b, 106c using the synthetic projection labeling service 214, the synthetic scan labeling service 216, and the localization and mapping labeling service 218, respectively.

The synthetic projection labeling service 214 can be embodied as one or more software applications or services executing on the computing device 202. The synthetic projection labeling service 214 can be executed by the processor 204 to generate the labeled visual dataset 106a based on the visual data 104a as described above with reference to FIG. 1. The synthetic projection labeling service 214 can generate the labeled visual dataset 106a such that it can be indicative of or include label data annotations that are applied to real-world imagery, such as real-world 2D images or video frames of a video. To generate the labeled visual dataset 106a, the synthetic projection labeling service 214 can implement the computer graphics application 220, which can include the same attributes and functionality as the computer graphics application described above with reference to FIG. 1.

In some examples, the synthetic projection labeling service 214 can use one or more algorithms or models described herein, such as an ML model or an AI model, to pre-define and label data. Should the data be correct, the process is simplified by a human-labeler approving the labeled data and moving onto the next data point.

In one example, to generate the labeled visual dataset 106a, the synthetic projection labeling service 214 can project synthetic data over real-world video and then extract the areas of interest. For example, the synthetic projection labeling service 214 can obtain real-world video of desired scenes or settings and create a virtual environment using the real-world video. The synthetic projection labeling service 214 can then add virtual objects to the environment and project the virtual objects in front of the real-world video background. The synthetic projection labeling service 214 can then raster the projected image and temporarily remove the real-world film and the virtual object while preserving the virtual object location in frame. The synthetic projection labeling service 214 can then depict relatively high-contrast virtual object subsets of the virtual object and create a relatively high contrast render. The synthetic projection labeling service 214 can then segment the high contrast raster and transfer the generated segmentations to the original image.

In some cases, the synthetic projection labeling service 214 can implement the computer graphics application 220 to access, for instance, a python API that can be associated with the computer graphics application 220. In this way, the synthetic projection labeling service 214 can programmatically perform various actions in a viewport and a render engine of the computer graphics application 220. For example, the synthetic projection labeling service 214 can implement the computer graphics application 220 to script the generation of renders at random positions and rotations to allow for the construction of a training set, such as the labeled visual dataset 106a, without the need for human intervention besides setting up the virtual environment and filming the videos as a background layer.

In this way, the synthetic projection labeling service 214 can achieve an automated labeling pipeline while still capturing real-world realism. Because the only “Person-Hours” investment is the setup of the virtual environment and filming the videos, the “Person-Hours per Labeled Frame” drops as the number of subsequent frames increases. This means time spent per frame trends toward zero as more frames are created for a training dataset, such as the labeled visual dataset 106a. There is an advantage of using an entirely virtual space, as it allows the ability to both create and automatically parse rastered images. The synthetic projection labeling service 214 can produce relatively high yields of labeled data by performing the automated labeling process described above. In one example, the synthetic projection labeling service 214 can produce 20 thousand labeled images overnight.

In some examples, the synthetic projection labeling service 214 can perform the above-described automated labeling process to generate the labeled visual dataset 106a using one or more of the methodologies described in U.S. Provisional Patent Application No. 63/363,526, the entire contents of which is incorporated herein by reference. In particular, in some cases, the synthetic projection labeling service 214 can perform the above-described automated labeling process to generate the labeled visual dataset 106a using one or more of the methodologies described in the paper titled “SEMI-AUTOMATED LABELING USING LIDAR, SEGMENTATION, AND REAL-WORLD IMAGERY” that is included in U.S. Provisional Patent Application No. 63/363,526. More specifically, in some cases, the synthetic projection labeling service 214 can perform the above-described automated labeling process to generate the labeled visual dataset 106a using one or more of the methodologies described in Section III.A. titled “Synthetic Projection Method” in the paper titled “SEMI-AUTOMATED LABELING USING LIDAR, SEGMENTATION, AND REAL-WORLD IMAGERY.”

The synthetic scan labeling service 216 can be embodied as one or more software applications or services executing on the computing device 202. The synthetic scan labeling service 216 can be executed by the processor 204 to generate the labeled visual dataset 106b based on the visual data 104b as described above with reference to FIG. 1. The synthetic scan labeling service 216 can generate the labeled visual dataset 106b such that it can be indicative of or include label data annotations that are applied to synthetic imagery, such as synthetic 2D images that can be generated based on a synthetic 3D reconstruction of a real-world scene. To generate the labeled visual dataset 106b, the synthetic scan labeling service 216 can implement the computer graphics application 220, which can include the same attributes and functionality as the computer graphics application described above with reference to FIG. 1.

In some examples, the synthetic scan labeling service 216 can obtain a relatively high-fidelity textured LiDAR scan of a real-world scene or setting. Based on such a scan, the synthetic scan labeling service 216 can construct a textured virtual environment and extract vertices from objects of interest. In this way, the synthetic scan labeling service 216 can generate the labeled visual dataset 106b such that it can include a plurality of labeled data for a given scene.

In some cases, the synthetic scan labeling service 216 can implement an automated labeling process that is similar the above-described process that can be implemented by the synthetic projection labeling service 214. However, in the automated labeling process that can be implemented by the synthetic scan labeling service 216, segmentations occur along vertices.

In one example, to generate the labeled visual dataset 106b, the synthetic scan labeling service 216 can obtain a textured LiDAR scan of a scene or area. The synthetic scan labeling service 216 can then select objects of interest from the resulting point cloud (also referred to as a “mesh”). The synthetic scan labeling service 216 can then view the scene from many angles and positions to develop a dataset. The synthetic scan labeling service 216 can then automatically segment and draw bounding boxes for objects of interest, thereby generating labels. The synthetic scan labeling service 216 can then transfer these generated labels to the LiDAR scene. In some cases, by performing the above-described automated labeling process, the synthetic scan labeling service 216 can generate the labeled visual dataset 106b such that it includes a predefined quantity of labeled images that can be defined by, for instance, a user implementing the computing device 102.

Because the automated labeling space exists in a static 3D space, the scene can be universally annotated by the synthetic scan labeling service 216 by defining the vertices of the objects of interest. In this case, by using the computer graphics application 220 suit of selection tools, the synthetic scan labeling service 216 can distinguish these objects from the other components of the scene. A selected vertex layer can then be isolated by the synthetic scan labeling service 216 to create the mask described above with reference to FIG. 1. The synthetic scan labeling service 216 can apply this automated labeling process to any object with a relatively high quality or high-resolution scan. Any number of annotated frames can be generated by the synthetic scan labeling service 216 from the single 3D vertex annotations. This automated labeling process that can be implemented by the synthetic scan labeling service 216 to generate the labeled visual dataset 106b also relies on the ability to obtain and map texture data to a mesh object. For some existing industrial LiDAR systems and other mapping solutions, such as stereographic implementations, this is this sometimes not possible or requires extra or unwanted processing.

In some examples, the synthetic scan labeling service 216 can perform the above-described automated labeling process to generate the labeled visual dataset 106b using one or more of the methodologies described in U.S. Provisional Patent Application No. 63/363,526, the entire contents of which is incorporated herein by reference. In particular, in some cases, the synthetic scan labeling service 216 can perform the above-described automated labeling process to generate the labeled visual dataset 106b using one or more of the methodologies described in the paper titled “SEMI-AUTOMATED LABELING USING LIDAR, SEGMENTATION, AND REAL-WORLD IMAGERY” that is included in U.S. Provisional Patent Application No. 63/363,526.More specifically, in some cases, the synthetic scan labeling service 216 can perform the above-described automated labeling process to generate the labeled visual dataset 106b using one or more of the methodologies described in Section III.B. titled “Synthetic LiDAR Scan Approach” in the paper titled “SEMI-AUTOMATED LABELING USING LIDAR, SEGMENTATION, AND REAL-WORLD IMAGERY.”

The localization and mapping labeling service 218 can be embodied as one or more software applications or services executing on the computing device 202. The localization and mapping labeling service 218 can be executed by the processor 204 to generate the labeled visual dataset 106c based on the visual data 104c as described above with reference to FIG. 1. The localization and mapping labeling service 218 can generate the labeled visual dataset 106c such that it can be indicative of or include label data annotations that are applied to real-world imagery, such a real-world 2D video frames of a video. To generate the labeled visual dataset 106c, the localization and mapping labeling service 218 can implement the computer graphics application 220, which can include the same attributes and functionality as the computer graphics application described above with reference to FIG. 1.

In some cases, to generate the labeled visual dataset 106c, the localization and mapping labeling service 218 can implement an automated labeling process of real-world video using at least one of a SLAM algorithm or a SAM algorithm (e.g., a LiDAR SLAM and/or a LiDAR SAM algorithm) in the same manner as described above with reference to FIG. 1. In this way, the localization and mapping labeling service 218 can provide an automated labeling pipeline that can be setup for an automated labeling environment or manual 3D modeling relatively quickly, not require any single frame annotations or textured data, decrease the average “Person-Hours per Frame” time as the number of labeled frames increases, and allow models to train on real-world videos and/or images rather than a synthetic re-creation. The segmentation process that can be implemented by the localization and mapping labeling service 218 to generate the labeled visual dataset 106c can combine the above-described process to achieve integrations with real world imagery.

In one example, to generate the labeled visual dataset 106c, the localization and mapping labeling service 218 can obtain a LiDAR scan that has been generated while at least one of a SLAM algorithm or a SAM algorithm (e.g., a LIO-SLAM algorithm and/or a LIO-SAM algorithm) was applied to the scan to obtain 3D positions. The localization and mapping labeling service 218 can also obtain a real-world video that was generated while the LiDAR scan was being generated. The localization and mapping labeling service 218 can then correlate the two data and perform vertex annotation similar to how the synthetic scan labeling service 216 performs such vertex annotation. The synthetic scan labeling service 216 can then develop the virtual dataset by mapping the SLAM and/or SAM poses to a virtual camera, such as a virtual camera that can be associated with the computer graphics application 220. The localization and mapping labeling service 218 can then develop and apply the annotations, for example, to one or more real-world 2D video frames.

In implementing the above-described automated labeling process, the localization and mapping labeling service 218 can perform a single annotation on an object inside the LiDAR scene and it is immediately and automatically applied to all real-world 2D video frames in an entire video. In this way, the localization and mapping labeling service 218 can increase efficiency as the number of frames increase, without requiring the use of textured data. In one example, to generate the labeled visual dataset 106c, the localization and mapping labeling service 218 can obtain a scan of a real-world space, extract the pose data as a time series, vertex label the scan in the computer graphics application 220, map the time series to a virtual camera associated with the computer graphics application 220, overlay the layers, and develop the labels apply them to the original footage.

In some examples, the localization and mapping labeling service 218 can perform the above-described automated labeling process to generate the labeled visual dataset 106c using one or more of the methodologies described in U.S. Provisional Patent Application No. 63/363,526, the entire contents of which is incorporated herein by reference. In particular, in some cases, the localization and mapping labeling service 218 can perform the above-described automated labeling process to generate the labeled visual dataset 106c using one or more of the methodologies described in the paper titled “SEMI-AUTOMATED LABELING USING LIDAR, SEGMENTATION, AND REAL-WORLD IMAGERY” that is included in U.S. Provisional Patent Application No. 63/363,526. More specifically, in some cases, the localization and mapping labeling service 218 can perform the above-described automated labeling process to generate the labeled visual dataset 106c using one or more of the methodologies described in Section III.C. titled “SLAM Real World Video” in the paper titled “SEMI-AUTOMATED LABELING USING LIDAR, SEGMENTATION, AND REAL-WORLD IMAGERY.”

The computer graphics application 220 can be embodied as one or more software applications or services executing on the computing device 202. The computer graphics application 220 can be executed by the processor 204 to facilitate the generation of the labeled visual datasets 106a, 106b, 106c by, for example, the computing device 102 using the synthetic projection labeling service 214, the synthetic scan labeling service 216, and the localization and mapping labeling service 218, respectively. For instance, the computer graphics application 220 can facilitate the generation of the labeled visual datasets 106a, 106b, 106c as described above with reference to FIG. 1.

In one example, the computer graphics application 220 can be embodied or implemented as a computer graphics animation application. The computer graphics application 220 can include tools and features that can be implemented by, for example, the computing device 102 using any or all of the synthetic projection labeling service 214, the synthetic scan labeling service 216, and the localization and mapping labeling service 218 to generate the labeled visual datasets 106a, 106b, 106c, respectively. For instance, the computer graphics application 220 can include tools and features that allow for at least one of visual data generation, rendering, annotation, and modification, raster graphics editing, digital drawing, 3D modeling, animation, simulation, texturing, UV mapping, UV unwrapping, rigging and skinning, compositing, sculpting, match moving, motion graphics, video editing, or another operation.

The computer graphics application 220 can also be associated with an API such as, for instance, a python-based API. The API can be accessed by, for example, the computing device 102 using any or all of the synthetic projection labeling service 214, the synthetic scan labeling service 216, and the localization and mapping labeling service 218 to perform any or all of the above-described operations. For example, the computer graphics application 220 can include a viewport or a render engine in which such operations can be programmatically performed.

The model training service 222 can be embodied as one or more software applications or services executing on the computing device 202. The model training service 222 can be executed by the processor 204 to train a model using any or all of the labeled visual datasets 106a, 106b, 106c such that, once trained, the model can detect an object in various visual data as described above with reference to FIG. 1. For instance, the model training service 222 can be implemented by the computing device 102 to train the trained model 108. In one example, the model training service 222 can train such a model using one or more training processes that can include, for instance, at least one of a supervised learning process, an unsupervised learning process, a semi-supervised learning process, a reinforcement learning process, or another learning process.

The communications stack 224 can include software and hardware layers to implement data communications such as, for instance, Bluetooth®, Bluetooth® Low Energy (BLE), WiFi®, cellular data communications interfaces, dedicated short-range communications (DSRC) interfaces, or a combination thereof. Thus, the communications stack 224 can be relied upon by the computing device 102 and the computing device 110 to establish DSRC, cellular, Bluetooth®, WiFi®, and other communications channels with the networks 112 and with one another.

The communications stack 224 can include the software and hardware to implement Bluetooth®, BLE, DSRC, and related networking interfaces, which provide for a variety of different network configurations and flexible networking protocols for short-range, low-power wireless communications. The communications stack 224 can also include the software and hardware to implement WiFi® communication, DSRC communication, and cellular communication, which also offers a variety of different network configurations and flexible networking protocols for mid-range, long-range, wireless, and cellular communications. The communications stack 224 can also incorporate the software and hardware to implement other communications interfaces, such as X10®, ZigBee®, Z-Wave®, and others. The communications stack 224 can be configured to communicate various data to and from the computing device 102 and the computing device 110. For example, the communications stack 224 can be configured to allow for the computing device 102 and the computing device 110 to share at least one of the visual data 104a, 104b, 104c, the labeled visual datasets 106a, 106b, 106c, the trained model 108, or other data.

The perception sensors 226 can be embodied as one or more perception sensors that can be included in or coupled (e.g., communicatively, operatively) to and used by, for instance, the computing device 102. In some cases, the perception sensors 226 can be embodied with or directly coupled to, for example, the computing device 102. The perception sensors 226 can be used to capture, measure, or generate sensor data (e.g., observational data) such as, for instance, vision-based sensor data. The sensor data can be indicative of a surrounding environment or a desired scene and it can be used by, for instance, the computing device 102 to generate any or all of the visual data 104a, 104b, 104c. The perception sensors 226 can include, but are not limited to, a camera (e.g., optical, thermographic), a stereo camera, radar, ultrasound or sonar, a LiDAR sensor or scanner, receivers for one or more global navigation satellite systems (GNSS) such as, for instance, the global positioning system (GPS), odometry, an inertial measurement unit (e.g., accelerometer, gyroscope, magnetometer), temperature, precipitation, pressure, and other types of sensors.

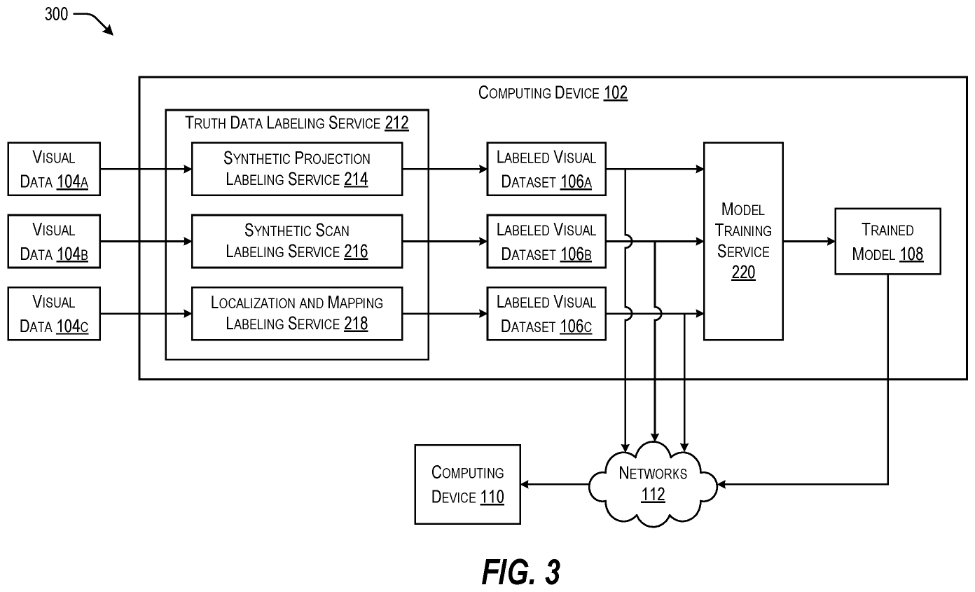

FIG. 3 illustrates an example data flow 300 that can be implemented to facilitate automated labeling of objects in visual data according to at least one embodiment of the present disclosure. In particular, the data flow 300 depicted in FIG. 3 can be implemented to perform the automated object labeling, training dataset generation, and model training processes described herein. The various operations associated with implementing the data flow 300 are described above with reference to the examples depicted in FIGS. 1 and 2. Therefore, details of such operations are not repeated here for purposes of brevity.

As described above with reference to FIGS. 1 and 2, collectively, the computing device 102 can include and implement any or all of the truth data labeling service 212, the synthetic projection labeling service 214, the synthetic scan labeling service 216, the localization and mapping labeling service 218, and the model training service 222. The computing device 102 can also include or be coupled to a scanner and a camera that can be operated by the computing device 102 to generate any or all of the visual data 104a, 104b, 104c. The computing device 102 can implement at least one of the synthetic projection labeling service 214, the synthetic scan labeling service 216, or the localization and mapping labeling service 218 to respectively generate the labeled visual datasets 106a, 106b, 106c based on the visual data 104a, 104b, 104c, respectively.

After generating any or all of the labeled visual datasets 106a, 106b, 106c, the computing device 102 can implement the model training service 222 to train a model to detect one or more particular objects depicted in various visual data based on any or all of the labeled visual datasets 106a, 106b, 106c. Once trained, the model training service 222 can output the trained model 108. In some cases, the computing device 102 can offload the model training operation to the computing device 110 by providing any or all of the labeled visual datasets 106a, 106b, 106c to the computing device 110 way of the networks 112. In some cases, the computing device 102 can send the trained model 108 to the computing device 110 by way of the networks 112.

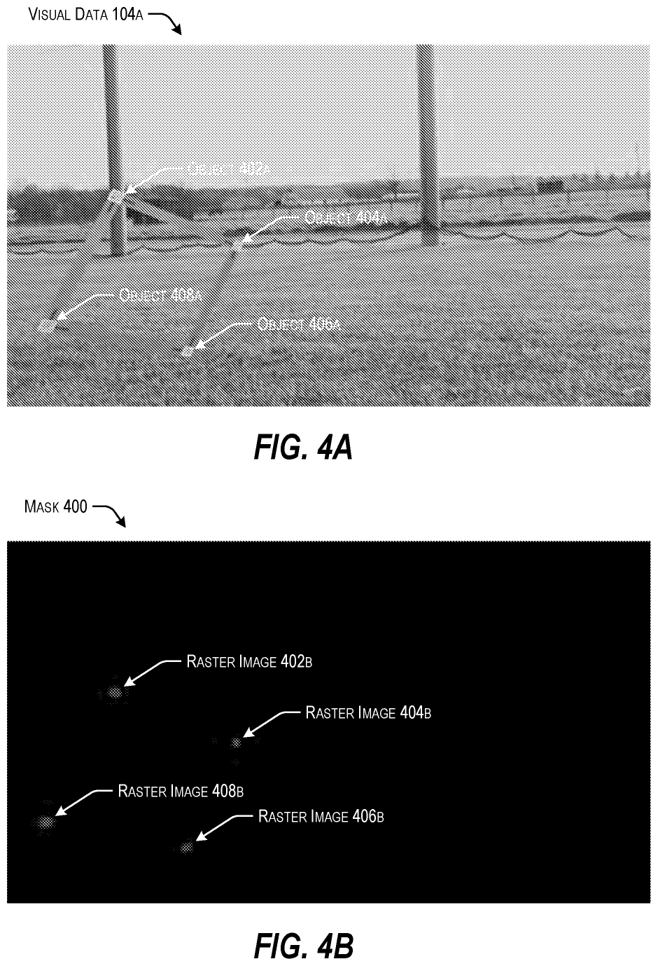

FIG. 4A illustrates an example of the visual data 104a depicting objects 402a, 404a, 406a, 408a that can be automatically labeled according to at least one embodiment of the present disclosure. As described above with reference to FIGS. 1 and 2, the computing device 102 can apply label data annotations to the objects 402a, 404a, 406a, 408a by respectively projecting a virtual object onto the objects 402a, 404a, 406a, 408a and then creating a raster image of each of the objects 402a, 404a, 406a, 408a based on the projection. The computing device 102 can then remove the real-world image and the virtual objects from the background to create a mask including the raster images respectively corresponding to the objects 402a, 404a, 406a, 408a.

FIG. 4B illustrates an example of a mask 400 that can facilitate automated labeling of objects in visual data according to at least one embodiment of the present disclosure. In this example, the mask 400 includes raster images 402b, 404b, 406b, 408b that respectively correspond to the objects 402a, 404a, 406a, 408a depicted in the visual data 104a depicted in FIG. 4A. As described above with reference to FIGS. 1 and 2, the computing device 102 can segment the mask 400 so as to extract or isolate each of the raster images 402b, 404b, 406b, 408b and respectively project the raster images 402b, 404b, 406b, 408b onto the objects 402a, 404a, 406a, 408a depicted in the visual data 104a. Each of the raster images 402b, 404b, 406b, 408b can be indicative of or include a ground truth label corresponding to the objects 402a, 404a, 406a, 408a, respectively. In this way, the computing device 102 can generate the labeled visual dataset 106a such that synthetically generated label data in the form of raster images can be applied to real-world objects depicted in the visual data 104a.

FIGS. 4A and 4B collectively correspond to the automated labeling method that can be performed by, for instance, the computing device 102 using the synthetic projection labeling service 214 and the computer graphics application 220 as described above with reference to FIGS. 1 and 2.

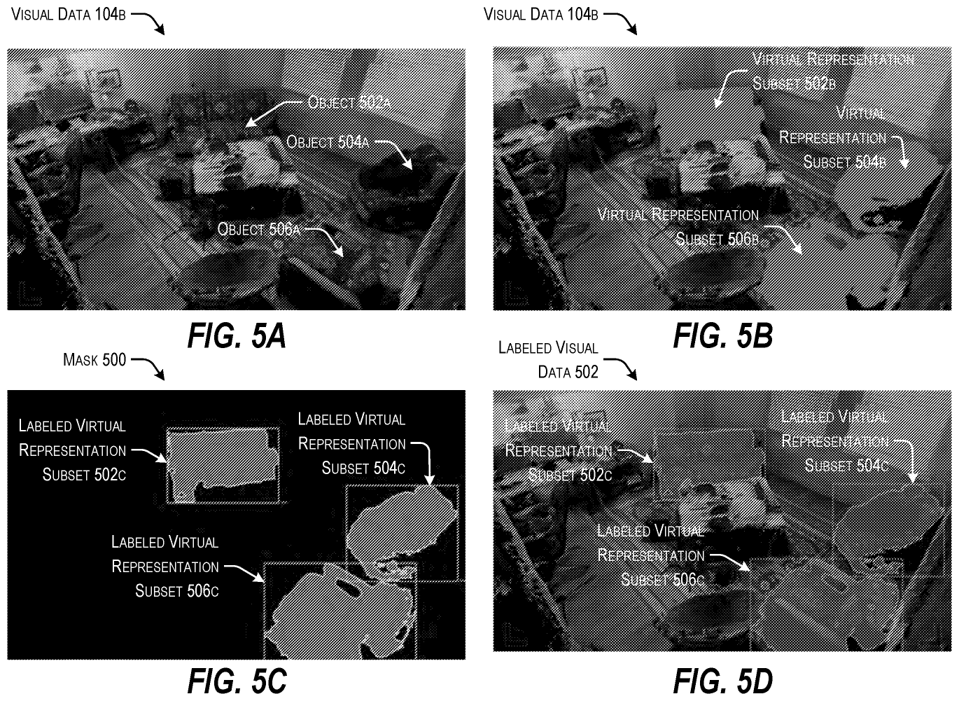

FIG. 5A illustrates an example of the visual data 104b depicting objects 502a, 504a, 506a that can be automatically labeled according to at least one embodiment of the present disclosure. As described above with reference to FIGS. 1 and 2, the visual data 104b can be a scan, such as a textured LiDAR scan, that can depict a real-world scene having real-world objects. For instance, the scan can depict the real-world scene and objects in a synthetic 3D reconstruction as illustrated in FIG. 5A. As such, each of the objects 502a, 504a, 506a can be a synthetic object that is representative of and corresponds to a real-world object. The computing device 102 can apply label data annotations to the objects 502a, 504a, 506a by generating a virtual representation, such as a 3D point cloud, having virtual representation subsets, such as 3D point cloud subsets, that respectively correspond to the objects 502a, 504a, 506a, for example, as depicted in FIG. 5B.

FIG. 5B illustrates an example of visual data 104b depicting virtual representation subsets 502b, 504b, 506b corresponding to the objects 502a, 504a, 506a, respectively, that can be automatically labeled according to at least one embodiment of the present disclosure. The virtual representation subsets 502b, 504b, 506b can be indicative of 3D point cloud subsets that can be representative of and correspond to the objects 502a, 504a, 506a, respectively. The computing device 102 can extract or isolate the virtual representation subsets 502b, 504b, 506b for label data annotation using a mask, for example, as depicted in FIG. 5C.

FIG. 5C illustrates an example of a mask 500 that can facilitate automated labeling of the objects 502a, 504a, 506a depicted in the visual data 104b according to at least one embodiment of the present disclosure. To generate the mask 500, the computing device 102 can remove the synthetic 3D reconstruction from the background to extract or isolate the virtual representation subsets 502b, 504b, 506b.

Once extracted, the computing device 102 can apply label data to each of the virtual representation subsets 502b, 504b, 506b to generate labeled virtual representation subsets 502c, 504c, 506c as depicted in FIG. 5C. The labeled virtual representation subsets 502c, 504c, 506c can include a vertex annotation respectively applied along vertices of the virtual representation subsets 502b, 504b, 506b, a bounding box respectively generated around the virtual representation subsets 502b, 504b, 506b, and/or encoded metadata indicative of a ground truth label respectively corresponding to the virtual representation subsets 502b, 504b, 506b and the real-world objects respectively corresponding to the objects 502a, 504a, 506a. The computing device 102 can segment the mask 500 so as to extract the labeled virtual representation subsets 502c, 504c, 506c and project them onto the synthetic 3D reconstruction of the real-world scene and objects as depicted in FIG. 5D.

FIG. 5D illustrates an example of labeled visual data 502 depicting the objects 502a, 504a, 506a that have been automatically labeled according to at least one embodiment of the present disclosure. The labeled visual data 502 can be indicative of a synthetic 2D image that can be generated by the computing device 102 based on the synthetic 3D reconstruction and labeled with label data annotations, such as the labeled virtual representation subsets 502c, 504c, 506c. The labeled visual data 502 can include the labeled virtual representation subsets 502c, 504c, 506c that can be segmented from the mask 500 and then projected onto the synthetic 2D image by the computing device 102. The labeled visual data 502 can be representative of a labeled synthetic 2D image that can be included in the labeled visual dataset 106b.

FIGS. 5A, 5B, 5C, and 5D collectively correspond to the automated labeling method that can be performed by, for instance, the computing device 102 using the synthetic scan labeling service 216 and the computer graphics application 220 as described above with reference to FIGS. 1 and 2.

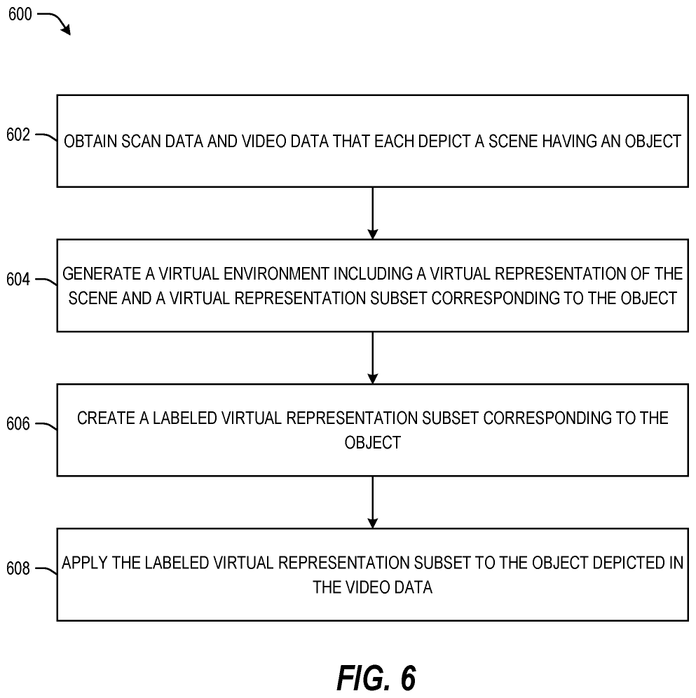

FIG. 6 illustrates a flow diagram of an example computer-implemented method 600 that can be implemented to facilitate automated labeling of objects in visual data according to at least one embodiment of the present disclosure. In one example, the computer-implemented method 600 (hereinafter, “the method 600”) can be implemented by the computing device 102. In another example, the method 600 can be implemented by the computing device 110. The method 600 can be implemented in the context of the environment 100, the computing environment 200 or another environment, and the data flow 300. In one example, the method 600 can be implemented to perform one or more of the operations described herein with reference to the examples depicted in FIGS. 1, 2, 3, 4A, 4B, 5A, 5B, 5C, and 5D.

At 602, the method 600 can include obtaining scan data and video data that each depict a scene having an object. For example, the computing device 102 can operate a LiDAR scanner and a camera that can respectively and, in some cases, simultaneously generate a LiDAR scan and a video of a real-world scene having a real-world object. The LiDAR scan can be a synthetic 3D reconstruction of the scene.

At 604, the method 600 can include generating a virtual environment including a virtual representation of the scene and a virtual representation subset corresponding to the object. For example, the computing device 102 can implement the computer graphics application 220 to generate a virtual representation of the scene, such as a 3D point cloud of the scene, in a virtual environment based on the scan data. For example, the computing device 102 can generate the virtual representation of the scene in the virtual environment based on the synthetic 3D reconstruction of the scene. The virtual representation can include a virtual representation subset, such as a 3D point cloud subset, corresponding to the object. Additionally, the virtual environment being associated with a virtual camera.

At 606, the method 600 can include creating a labeled virtual representation subset corresponding to the object. For example, the computing device 102 can further implement the computer graphics application 220 to apply label data to the virtual representation subset to create a labeled virtual representation subset, such as a labeled 3D point cloud subset, corresponding to the object.

At 608, the method 600 can include applying the labeled virtual representation subset to the object depicted in the video data. For example, the computing device 102 can further implement the computer graphics application 220 to apply the labeled 3D point cloud subset to the object depicted in one or more real-world 2D video frames of a video based on a correlation of the scanner, the camera, and the virtual camera. For instance, the computing device 102 can apply the labeled 3D point cloud subset to the object depicted in one or more real-world 2D video frames of a video based on a correlation of pose data or time series pose data respectively corresponding to the scanner, the camera, and the virtual camera.

Referring now to FIG. 2, an executable program can be stored in any portion or component of the memory 206 including, for example, a random access memory (RAM), read-only memory (ROM), magnetic or other hard disk drive, solid-state, semiconductor, universal serial bus (USB) flash drive, memory card, optical disc (e.g., compact disc (CD) or digital versatile disc (DVD)), floppy disk, magnetic tape, or other types of memory devices.

In various embodiments, the memory 206 can include both volatile and nonvolatile memory and data storage components. Volatile components are those that do not retain data values upon loss of power. Nonvolatile components are those that retain data upon a loss of power. Thus, the memory 206 can include, for example, a RAM, ROM, magnetic or other hard disk drive, solid-state, semiconductor, or similar drive, USB flash drive, memory card accessed via a memory card reader, floppy disk accessed via an associated floppy disk drive, optical disc accessed via an optical disc drive, magnetic tape accessed via an appropriate tape drive, and/or other memory component, or any combination thereof. In addition, the RAM can include, for example, a static random-access memory (SRAM), dynamic random-access memory (DRAM), or magnetic random-access memory (MRAM), and/or other similar memory device. The ROM can include, for example, a programmable read-only memory (PROM), erasable programmable read-only memory (EPROM), electrically erasable programmable read-only memory (EEPROM), or other similar memory device.

As discussed above, the truth data labeling service 212, the synthetic projection labeling service 214, the synthetic scan labeling service 216, the localization and mapping labeling service 218, the computer graphics application 220, the model training service 222, and the communications stack 224 can each be embodied, at least in part, by software or executable-code components for execution by general purpose hardware. Alternatively, the same can be embodied in dedicated hardware or a combination of software, general, specific, and/or dedicated purpose hardware. If embodied in such hardware, each can be implemented as a circuit or state machine, for example, that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components.

Referring now to FIG. 6, the flowchart or process diagram shown in FIG. 6 is representative of certain processes, functionality, and operations of the embodiments discussed herein. Each block can represent one or a combination of steps or executions in a process. Alternatively, or additionally, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as the processor 204. The machine code can be converted from the source code. Further, each block can represent, or be connected with, a circuit or a number of interconnected circuits to implement a certain logical function or process step.

Although the flowchart or process diagram shown in FIG. 6 illustrates a specific order, it is understood that the order can differ from that which is depicted. For example, an order of execution of two or more blocks can be scrambled relative to the order shown. Also, two or more blocks shown in succession can be executed concurrently or with partial concurrence. Further, in some embodiments, one or more of the blocks can be skipped or omitted. In addition, any number of counters, state variables, warning semaphores, or messages might be added to the logical flow described herein, for purposes of enhanced utility, accounting, performance measurement, or providing troubleshooting aids. Such variations, as understood for implementing the process consistent with the concepts described herein, are within the scope of the embodiments.

Also, any logic or application described herein, including the truth data labeling service 212, the synthetic projection labeling service 214, the synthetic scan labeling service 216, the localization and mapping labeling service 218, the computer graphics application 220, the model training service 222, and the communications stack 224 can be embodied, at least in part, by software or executable-code components, can be embodied or stored in any tangible or non-transitory computer-readable medium or device for execution by an instruction execution system such as a general-purpose processor. In this sense, the logic can be embodied as, for example, software or executable-code components that can be fetched from the computer-readable medium and executed by the instruction execution system. Thus, the instruction execution system can be directed by execution of the instructions to perform certain processes such as those illustrated in FIG. 6. In the context of the present disclosure, a non-transitory computer-readable medium can be any tangible medium that can contain, store, or maintain any logic, application, software, or executable-code component described herein for use by or in connection with an instruction execution system.

The computer-readable medium can include any physical media such as, for example, magnetic, optical, or semiconductor media. More specific examples of suitable computer-readable media include, but are not limited to, magnetic tapes, magnetic floppy diskettes, magnetic hard drives, memory cards, solid-state drives, USB flash drives, or optical discs. Also, the computer-readable medium can include a RAM including, for example, an SRAM, DRAM, or MRAM. In addition, the computer-readable medium can include a ROM, a PROM, an EPROM, an EEPROM, or other similar memory device.

Disjunctive language, such as the phrase “at least one of X, Y, or Z,” unless specifically stated otherwise, is to be understood with the context as used in general to present that an item, term, or the like, can be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present.

As referenced herein, the term “user” refers to at least one of a human, an end-user, a consumer, a computing device and/or program (e.g., a processor, computing hardware and/or software, an application), an agent, an ML and/or AI model, and/or another type of user that can implement and/or facilitate implementation of one or more embodiments of the present disclosure as described herein, illustrated in the accompanying drawings, and/or included in the appended claims. As referred to herein, the terms “includes” and “including” are intended to be inclusive in a manner similar to the term “comprising.” As referenced herein, the terms “or” and “and/or” are generally intended to be inclusive, that is (i.e.), “A or B” or “A and/or B” are each intended to mean “A or B or both.” As referred to herein, the terms “first,” “second,” “third,” and so on, can be used interchangeably to distinguish one component or entity from another and are not intended to signify location, functionality, or importance of the individual components or entities. As referenced herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling), mechanical coupling, operative coupling, optical coupling, and/or physical coupling.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

1. A method to label one or more objects captured in visual data, comprising:
obtaining, by a computing device, scan data and video data that each depict a scene comprising an object, the scan data being generated by a scanner and the video data being generated by a camera;
generating, by the computing device, a virtual representation of the scene in a virtual environment based on the scan data, the virtual representation comprising a virtual representation subset corresponding to the object, and the virtual environment being associated with a virtual camera;
applying, by the computing device, label data to the virtual representation subset to create a labeled virtual representation subset corresponding to the object; and
applying, by the computing device, the labeled virtual representation subset to the object depicted in the video data based on a correlation of the scanner, the camera, and the virtual camera.

2. The method of claim 1, further comprising:
generating, by the computing device, a labeled visual dataset based on the video data and the labeled virtual representation subset corresponding to the object, the labeled visual dataset comprising an annotation of the labeled virtual representation subset applied to the object in one or more video frames of the video data.

3. The method of claim 2, further comprising:
training, by the computing device, a model to detect the object in different visual data based on the labeled visual dataset, the different visual data depicting a different scene comprising the object.

4. The method of claim 1, wherein generating the virtual representation of the scene in the virtual environment based on the scan data comprises:
capturing, by the computing device, a light detection and ranging (LiDAR) scan of the scene, the LiDAR scan comprising the scan data; and
rendering, by the computing device, the LiDAR scan in the virtual environment to generate the virtual representation in the virtual environment based on the LiDAR scan.

5. The method of claim 1, wherein generating the virtual representation of the scene in the virtual environment based on the scan data comprises:
applying, by the computing device, a smoothing and mapping (SAM) algorithm to the scan data; and
tracking, by the computing device, three-dimensional (3D) location data corresponding to at least one of the object or the virtual representation subset with respect to at least one vantage point of the virtual camera based on applying the SAM algorithm to the scan data.

6. The method of claim 1, wherein applying the label data to the virtual representation subset to create the labeled virtual representation subset corresponding to the object comprises:
applying, by the computing device, the label data to the virtual representation subset to create the labeled virtual representation subset corresponding to the object based on receipt of input data that is indicative of a selection of at least one of the virtual representation subset or the object for label data annotation.

7. The method of claim 1, wherein applying the label data to the virtual representation subset to create the labeled virtual representation subset corresponding to the object comprises:
extracting, by the computing device, a subset of three-dimensional (3D) point cloud data that is indicative of the virtual representation subset and the object from a 3D point cloud dataset that is indicative of the virtual representation and the scene; and
applying, by the computing device, the label data to the subset of 3D point cloud data to create the labeled virtual representation subset corresponding to the object.

8. The method of claim 1, wherein applying the label data to the virtual representation subset to create the labeled virtual representation subset corresponding to the object comprises:
applying, by the computing device, a vertex annotation along vertices of the virtual representation subset;
generating, by the computing device, a bounding box around the virtual representation subset; and
associating, by the computing device, metadata indicative of the object with at least one of the virtual representation subset, the vertex annotation, or the bounding box.

9. The method of claim 1, wherein applying the labeled virtual representation subset to the object depicted in the video data based on the correlation of the scanner, the camera, and the virtual camera comprises:
applying, by the computing device, the labeled virtual representation subset to the object depicted in one or more video frames of the video data based on a correlation of pose data respectively corresponding to the scanner, the camera, and the virtual camera.

10. The method of claim 1, further comprising:
mapping, by the computing device, first time series pose data of the scanner to second time series pose data of the camera and third time series pose data of the virtual camera to correlate the scanner, the camera, and the virtual camera.

11. A computing device, comprising:
a memory device to store computer-readable instructions thereon; and
at least one processing device configured through execution of the computer-readable instructions to:
obtain scan data and video data that each depict a scene comprising an object, the scan data being generated by a scanner and the video data being generated by a camera;
generate a virtual representation of the scene in a virtual environment based on the scan data, the virtual representation comprising a virtual representation subset corresponding to the object, and the virtual environment being associated with a virtual camera;
apply label data to the virtual representation subset to create a labeled virtual representation subset corresponding to the object; and
apply the labeled virtual representation subset to the object depicted in the video data based on a correlation of the scanner, the camera, and the virtual camera.

12. The computing device of claim 11, wherein, to generate the virtual representation of the scene in the virtual environment based on the scan data, the at least one processing device is further configured to:
capture a light detection and ranging (LiDAR) scan of the scene, the LiDAR scan comprising the scan data; and
render the LiDAR scan in the virtual environment to generate the virtual representation in the virtual environment based on the LiDAR scan.

13. The computing device of claim 11, wherein, to generate the virtual representation of the scene in the virtual environment based on the scan data, the at least one processing device is further configured to:
apply a smoothing and mapping (SAM) algorithm to the scan data; and
track three-dimensional (3D) location data corresponding to at least one of the object or the virtual representation subset with respect to at least one vantage point of the virtual camera based on applying the SAM algorithm to the scan data.

14. The computing device of claim 11, wherein, to apply the label data to the virtual representation subset to create the labeled virtual representation subset corresponding to the object, the at least one processing device is further configured to:
apply the label data to the virtual representation subset to create the labeled virtual representation subset corresponding to the object based on receipt of input data that is indicative of a selection of at least one of the virtual representation subset or the object for label data annotation.

15. The computing device of claim 11, wherein, to apply the label data to the virtual representation subset to create the labeled virtual representation subset corresponding to the object, the at least one processing device is further configured to:
extract a subset of three-dimensional (3D) point cloud data that is indicative of the virtual representation subset and the object from a 3D point cloud dataset that is indicative of the virtual representation and the scene; and
apply the label data to the subset of 3D point cloud data to create the labeled virtual representation subset corresponding to the object.

16. The computing device of claim 11, wherein, to apply the label data to the virtual representation subset to create the labeled virtual representation subset corresponding to the object, the at least one processing device is further configured to:
apply a vertex annotation along vertices of the virtual representation subset;
generate a bounding box around the virtual representation subset; and
associate metadata indicative of the object with at least one of the virtual representation subset, the vertex annotation, or the bounding box.

17. The computing device of claim 11, wherein, to apply the labeled virtual representation subset to the object depicted in the video data based on the correlation of the scanner, the camera, and the virtual camera, the at least one processing device is further configured to:
apply the labeled virtual representation subset to the object depicted in one or more video frames of the video data based on a correlation of pose data respectively corresponding to the scanner, the camera, and the virtual camera.

18. A non-transitory computer-readable medium embodying at least one program that, when executed by at least one computing device, directs the at least one computing device to:
obtain scan data and video data that each depict a scene comprising an object, the scan data being generated by a scanner and the video data being generated by a camera;
generate a virtual representation of the scene in a virtual environment based on the scan data, the virtual representation comprising a virtual representation subset corresponding to the object, and the virtual environment being associated with a virtual camera;
apply label data to the virtual representation subset to create a labeled virtual representation subset corresponding to the object; and
apply the labeled virtual representation subset to the object depicted in the video data based on a correlation of the scanner, the camera, and the virtual camera.

19. The non-transitory computer-readable medium according to claim 18, wherein, to generate the virtual representation of the scene in the virtual environment based on the scan data, the at least one computing device is further directed to:
capture a light detection and ranging (LiDAR) scan of the scene, the LiDAR scan comprising the scan data; and
render the LiDAR scan in the virtual environment to generate the virtual representation in the virtual environment based on the LiDAR scan.

20. The non-transitory computer-readable medium according to claim 18, wherein, to generate the virtual representation of the scene in the virtual environment based on the scan data, the at least one computing device is further directed to:
apply a smoothing and mapping (SAM) algorithm to the scan data; and
track three-dimensional (3D) location data corresponding to at least one of the object or the virtual representation subset with respect to at least one vantage point of the virtual camera based on applying the SAM algorithm to the scan data.
